(19) United States
(12) Patent Application Publication
(10) Pub. No.: US 2007/0189333 A1
(43) Pub. Date: Aug. 16, 2007

(54) Time synchronization of digital media

(75) Inventors: Mor Naaman, San Francisco, CA (US); Marc E. Davis, San Francisco, CA (US); Nathaniel S. Good, Albany, CA (US); Leonard H. Lin, Palo Alto, CA (US); Gordon D. Luk, Sunnyvale, CA (US); Andrew C. Baio, Palo Alto, CA (US)

Correspondence Address: MORRISON & FOERSTER LLP, 425 MARKET STREET, SAN FRANCISCO, CA, 94105-2482, US

(73) Assignee: Yahool Inc., Sunnyvale, CA (US)

(21) Appl. No.: 11/353,657

(22) Filed: Feb. 13, 2006

(51) Int. Cl. H04J 3/18

(52) U.S. Cl. 370/477; 370/503

(57) ABSTRACT

Provided are methods, processing systems and media content devices for associating a device clock from a media content device and a reference time external to the media content device for: receiving media content containing a representation of the reference time; determining a timestamp derived from the device clock, wherein the timestamp is associated with the received media content; and reconstructing the reference time from the media content.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A COMPACT DISK APPENDIX

Not Applicable.

### BACKGROUND OF THE INVENTION

1. Field of the Invention

The present invention relates generally to compensating for discrepancies between a time on a media device and a reference time, and specifically though not exclusively to synchronizing media content from such a media device or devices.

2. Description of the Related Art

Audio, video and image content from media capture devices, such as digital camera (providing still images), digital video cameras (providing audio/video moving images and/or video only moving images), audio recorders such as in digital players or advanced keyboards (providing audio tracks) and combination media devices (providing still images, audio and/or video), are shared more and more frequently. Many of these media capture devices have an internal clock used to timestamp content as it is collected. The timestamp may represent a time of day, a date, or a combined date and time, each referred to simply as “time” below.

Often a user is required to set the internal device clock manually, which may be a cumbersome, burdensome, non-intuitive or inconvenient process. In any case, a device's internal clock may be off by a few seconds, a few minutes or might not be set at all and reflect only the duration of time since that device was activated. Furthermore, the device time may drift over the lifetime of the device. For these reasons, the device's internal clock usually does not precisely reflect the absolute time.

For example, in the latest models of digital cameras, the burden of setting the clock correctly is inflicted upon the camera owner. As a consequence, the digital camera clock is often not set correctly and does not reflect the correct time. In addition, time-aligning photos from different cameras compounds the problem, as each camera provides a different time.

With respect to cameras and photos, current solutions require users to manually adjust capture times or to manually synchronize photos from disparate cameras, for example, by visual inspection of each photo's content or adjusting time directly on the camera. Even if users undertake this manual time adjustment process, in order to synchronize multiple users' photos, users need to set the clocks precisely to a common time and time zone for each camera, which may be a considerably challenging task.

Devices may integrate an inaccurate timestamp with the content and/or may keep it separate from the content. For example, the timestamp may be integrated within the collected content itself, such as a date/time overlaying at the bottom corner of a photograph. As another example, the timestamp may be apart from but associated with the collected content, such as in a file containing both the content in the file's body and metadata in the file's header. The metadata may include one or more time fields such as date, time of day and duration of when the content was created or modified.

The present invention seeks to alleviate one or more issues resulting from multiple clocks internal to and external from one or more media capture devices.

### BRIEF SUMMARY OF THE INVENTION

Embodiments of the present invention provide a method, processing system or media content device for associating a device clock from a media content device and a reference time external to the media content device. Some embodiments of the present invention further provide for receiving media content containing a representation of the reference time; determining a timestamp derived from the device clock, wherein the timestamp is associated with the received media content; and reconstructing the reference time from the media content.

Some embodiments of the present invention further provide for correlating the timestamp and the reconstructed reference time, for example, wherein correlating the timestamp and the reconstructed reference time comprises computing a difference between the timestamp and the reconstructed reference time, and/or wherein the media content comprises a video, and/or wherein the media content comprises a photographic image, and/or wherein determining the timestamp comprises extracting one or more time parameters from a header associated with the media content, and/or wherein determining the timestamp comprises determining the timestamp from a file creation time, and/or wherein reconstructing the reference time comprises decoding a bar code, and/or wherein the bar code comprises a two-dimensional (2-D) bar code.

Some embodiments of the present invention further provide for reconstructing the reference time comprises performing optical character recognition (OCR) on at least a portion of the media content, and/or selecting a set of media content based on one or more configuration parameters, for example, wherein at least one of the one or more configuration parameters comprises a time span, and/or wherein at least one of the one or more configuration parameters comprises one or more uploading events, and/or setting an adjusted time associated with the media content based on at least one of the one or more configuration parameters.

Some embodiments of the present invention further provide for setting an adjusted time associated with the media content based on the computed difference. Some embodiments of the present invention further provide for setting an adjusted time associated with the media content based on the timestamp and the reconstructed reference time. Some embodiments of the present invention further provide for detecting whether or not a portion of the received media content contains a representation of a reference time, and/or receiving additional media content void of the representation of the reference time, for example, for detecting that the additional media content is void of the representation of the reference time, and/or setting an adjusted time associated with the additional media content based on the timestamp and the reconstructed reference time, and/or wherein the reference time represents a universal coordinated time, and/or wherein the reference time comprises a local time. Some embodiments of the present invention further provide generating the representation of the reference time and/or providing the representation of the reference time to a web page.

The invention provides several ways to correct the image times by determining the offset, and adding/subtracting the offset to a collection of images taken with a digital camera. The fundamental goal is to provide a link between the time on the server and the time on the device. Several methods are described below.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 shows an exemplary system for time synchronization of media content, in accordance with some embodiments of the present invention.

FIGS. 2A through 2E presents user and system process flows, in accordance with some embodiments of the present invention.

FIG. 3 presents another process flow, in accordance with some embodiments of the present invention.

FIG. 4 illustrates an example screenshot showing an encoded 2-dimensional (2-D) barcode representation of a reference time, in accordance with some embodiments of the present invention.

FIG. 5 illustrates an example image captured by a media capture device of the screenshot of FIG. 4, in accordance with some embodiments of the present invention.

FIG. 6 shows information associated with a captured image, in accordance with some embodiments of the present invention.

FIG. 7 shows information associated with a processed image, in accordance with some embodiments of the present invention.

### DETAILED DESCRIPTION OF THE INVENTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description that follows are presented in terms of procedures, steps, logic blocks, processing, and other symbolic representations of operations on data bits that can be performed on computer memory. A procedure, computer executed step, logic block, process, etc., are here conceived to be a self-consistent sequence of steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

In some embodiments of the present invention, a user views a web page that lists the time of a server and manually inputs the time that is displayed on their media content device onto the web page. When the user submits this information, a link is established between the time entered from the media content device clock and the time on the server.

In some embodiments of the present invention, a users take a picture on an image encoded with a reference time, for example, a reference time from a server. Therefore, a timestamp derived from the media content device clock and the reference time are encoded together. Thereafter, a user may later upload the image for processing. In addition, the reference time encoded in the captured image from and the media capture device clock are accurate coordinated. The uploaded content may also contain additional useful metadata without any user intervention or input. The media content device and the server perform the otherwise cumbersome tasks of reconciling discrepancies in various clocks.

For example, a server provides the user with an image encoded with the server time in GMT. The time is written on the screen and is also encoded in a bar code. So that the time will be accurate, the page refreshes the image every couple of seconds. The users then take a picture of this screen, thereby encoding the image on the digital camera with the image embedded in the barcode. The user then uploads this image to the server using the upload screen. The server then uses an image parsing algorithm to parse out the GMT time embedded in the barcode. Alternately, the image parsing algorithm could use OCR to parse out the text as well.

An image taken by a digital camera may have an “EXIF” header including the date and time. In this case, deriving a time offset may require the server to read the date and time embedded in the EXIF header of the uploaded image. In some cases, the image may not hold an EXIF header and therefore the time of the image capture most be obtained from the file creation time. The information in the photo's metadata header (EXIF) may tell a system what is the camera clock time at the moment the photo was taken (exposureCamClock) for example as a timestamp. The offset between the accurate reference time and the camera time, CamOffset =exposureUTC−exposureCamClock, can be then applied by the system to all photos from the same camera.

When an image is uploaded through the web, the file creation time on the server is the time that the image was uploaded. Since this may be different than the actual time that the image was taken on the digital camera, there may be a way to preserve the file creation time for the image when the image is created. This preservation may be accomplished by a client application that resides on the user's machine. The client application may accept images with embedded time information.

When the digital camera is connected to the user's machine, the user may drag or copy the images to the client application. Because the images are on the same file system, the client application recognizes and preserves the file creation time. The client application then performs the same or similar image analysis as may otherwise be performed on a server, for example, parsing the image for the GMT time and any additional meta-data. In the case that there is no EXIF header information (or other type of metadata), the file creation time may be used. After this timing or clock information is obtained, an offset can be uploaded to the server and/or may be used locally. Additionally in some embodiments, the client may mark batches of images for offset adjustment.

Some embodiments of the present invention allow users to reconcile the clock differences on their digital capture devices with the correct time on a server using preexisting technology. Some embodiments of the present invention allow batch correction of image time, thereby reducing the possibility for human error by automating the collection and computation of the offset, and greatly simplifying a rather tedious and complex task of correcting the time of past and present pictures.

Fortunately, the internal clock of a typical media capture device provides timestamps that reflect relative time among captured content with sufficient accuracy. For example, if a camera's internal clock provides timestamps indicating a second photo was taken an hour after a first photo and a system can access an external reference time indicating when the first photo was taken, the system can determine the absolute time the second photo was taken by the camera. Furthermore, this process provides an absolute time any photo, taken either before or after the first photo, was captured.

A system or method according to some embodiments of the present invention automatically or semi-automatically adjusts timestamps of multiple captured media content (such as photos, audio clips, videos or combinations thereof) captured from a single media capture device (such as a camera, audio recorder, video recorder, multi-function devices, or the like). Furthermore, a system or method according to other embodiments of the present invention provides accurate synchronization among multiple media capture devices. According to embodiments of the present invention, a user captures content that has a reference timestamp imbedded within the content. The media capture device associates a timestamp provided by its internal clock to the captured content. Thus, the captured content provides a fixed association between the reference time and the internal clock.

For example, a user may use a digital camera to take a digital photo of a computer screen displaying a reference time. The digital camera tags the captured photo with a timestamp derived from its internal clock. Thus, by extracting the timestamp and the captured reference time, the captured photo may be used to correlate the camera's time with the external reference time. The correlation may be used to set an adjusted time for other photos taken before and after this reference photo. The correlation process is a direct result from a user taking a photo of a reference time, thus associating the camera's time with an external reference time.

Some embodiments of the present invention assist in synchronizing time among content from multiple media content devices. In many cases, users are unable or unwilling to set the clock correctly on their media capture devices such as digital camera. Inaccurate clocks result in media content having incorrect timestamps. When these images are uploaded and posted to a server to be shared or viewed by others, the displayed time is incorrect making searching, browsing and sharing of images troublesome. In some cases, the number of media content with incorrect times is quite large, therefore making changing the displayed times manually tedious.

Several methods may be used to provide an accurate timestamp for media content. A user may manually adjust the internal clock of a media capture device. A user may use a processing system to correlate media content with a reference time. The reference time is provided externally from the media capture device and may be presented to the media capture device visually and/or audibly, as well as encoded or unencoded. The processing system may be incorporated within the media capture device, may be external to the media capture device, or may be a combination of internal and external incorporation. Sections of the processing system that are external to the media capture device may reside on one or more systems such as completely within or partially within a user's home computer and/or one or more networked servers. The processing system may reside entirely with a user's home computer. Alternatively, the processing system may reside completely remote from the user, such as on a remote media server.

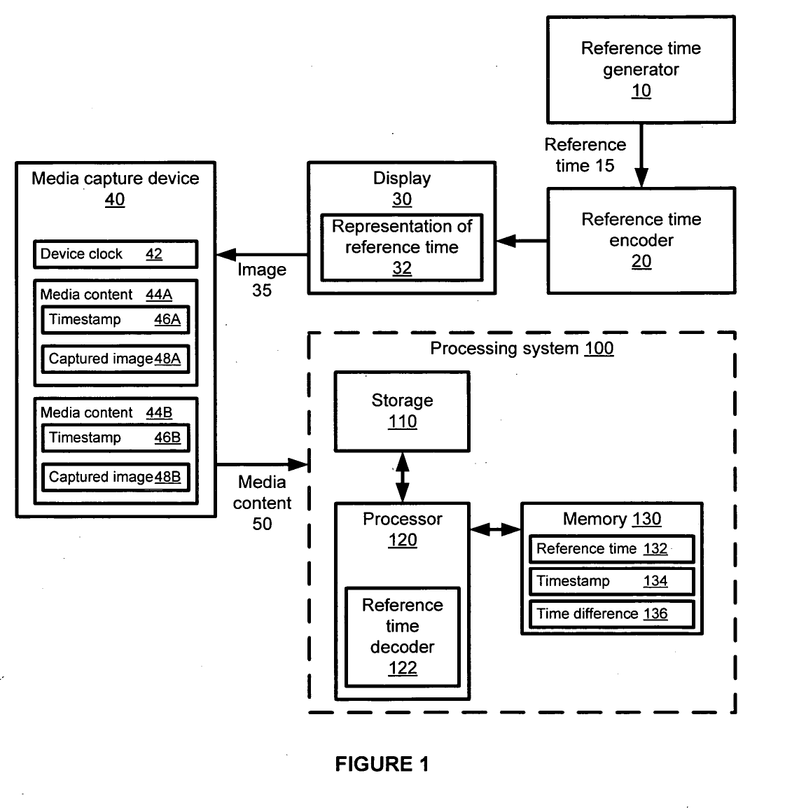

FIG. 1 shows an exemplary system for time synchronization of media content, in accordance with some embodiments of the present invention. A reference time generator 10, external to a media capture device 40, provides a reference time 15. This reference time 15 may be updated and provided periodically (e.g., every second or every fixed number of seconds). The reference time generator 10, though external to the media capture device 40, may be internal or external to a processing system 100, which is further described below.

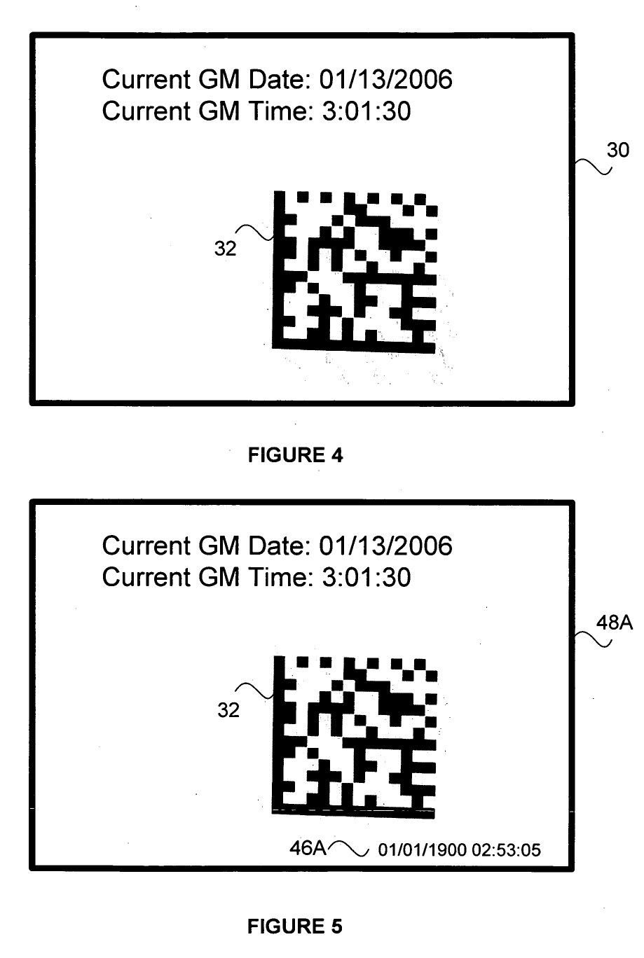

An optional reference time encoder 20 may be used to encode the reference time 15 in a medium that may be captured by a media capture device 40. For a media capture device 40 that captures audio, the reference time encoder 20 may encode the reference time 15 as a sequence of audible tones (e.g., DTMF tones, 300 baud modem tones or the like). For a media capture device 40 that captures images or video, the reference time encoder 15 may encode the reference time 15 as a one-dimensional (1-D) barcode, a two-dimensional (2-D) barcode (e.g., see FIG. 4 described below) or the like. Alternatively, the reference time 15 may be presented in a human understandable form such as an audible reading of the reference time or a visual presentation via a clock or common Arabic numerals and punctuation.

A presentation device, such as a display 20 of a computer or audio player (not shown), may be used to present a representation 32 of the reference time 15. For example, a user's home computer may be used to access and display on its display 20 a 2-D barcode containing an encoded reference time. An applet running on the home computer may periodically update the presented representation of the reference time. In some embodiments, a web browser and/or an applet local to a user's computer receive and present an already encode reference time. In some embodiments, a web browser and/or an applet local to a user's computer receive an unencoded reference time and locally encode the reference time for presentation. In some embodiments, web browser and/or an applet present both encoded and unencoded representations concurrently

A media capture device 40 includes an internal device clock 42. This device clock 42 provides a time or timestamp that is separate and distinct from the reference time 15 provided reference time generator 10. It may happen that the two times are identical, however, it is more probable that the device time is either unset or has some positive or negative offset from the reference time. According to embodiments of the present invention, this offset may be determined on a case-by-case basis.

The media capture device 40 further includes a memory to hold captured media content 44. Shown as first media content 44A, the media capture device 40 associates a timestamp 46A, which represents the time the content was captured, with captured content, such as a captured image 48A. This timestamp 46A is produced from the media capture device's internal clock 42 and is associated with the captured content such as being part of a header of a file containing the captured content.

In the example shown, the captured image 48A includes an image 35 from display 30. According to embodiments of this invention, the media content 44A may be processed to find a time relationship between reference times 15 produced by the reference time generator 15 and the device clock 42. The example shows a second media content 44B containing a second timestamp 46B and a second captured image 48B. The timestamp 46B indicates time that the captured image 48B was taken. The captured image 48B may be any image a user would typically take when using a camera. There may also be many more additional such captured images.

The media capture device 40 further includes a processor (not shown). The processor may be a general purpose processor, an application specific integrated circuit, an array of logic gates and/or the like. The processor may include functional code and/or hardware to perform various media capture device specific tasks.

The media capture device 40 provides media content 50 to a processing system 100. The processing system 100 may be fully internal to the media capture device 40, fully external from media capture device 40, or a partially internal to the media capture device 40.

The processing system 100 includes storage 110 to hold media content 44 with or without the timestamp 46. That is, the timestamp 46 may be stored in separate memory. The storage 110 may include a single hard drive, an array of redundant hard drives, a network of short-term or long-term, persistent or non-persistent memory. The storage 110 may be internal and/or external to the media capture device 40. The storage 110 may be local to a user's client computer, such as in a home personal computer, or may be part of a remote server.

The processing system 100 further includes a processor 120. If the processor 120 is internal to the media capture device 40, processor 120 and the media capture device 40 processor (not shown) discussed above may be the same processor. Again, the processor 120 may be a general purpose processor, an application specific integrated circuit, an array of logic gates and/or the like. Furthermore, the processor 120 may be part of a server or a network of servers. The processor 120 may be a single processor or an arraignment of multiple associated processors. The processor 120 may include functional code and/or hardware to perform various media processing and manipulation functions.

The media capture device 40 may provide the media content 50 directly to storage or the media content 50 may pass through the processor 120 first. The processor 120 includes a reference time decoder 122, which may be code and/or hardware and may be one or more tasks, threads, procedures, processes and/or the like.

The reference time decoder 122 reconstructs a reference time 15 by extracting the reference time 15 from media content 50 containing the representation 22 of the reference time. The decoder 122 may perform optical character recognition (OCR), voice recognition (VR), 1-D barcode decoding, 2-D barcode decoding, DTMF or modem decoding and/or the like.

The processor 120 also extracts the timestamp 46 from the media content 44. In some embodiments, the timestamp 46 is extracted from a header file in which the media content 44 is provided. In some embodiments, the timestamp 46 is extracted from a file's creation or modification time. In other embodiments in which the media content 44 contains an integrated timestamp 46 within the captured content 48, the processor 120 extracted from the timestamp 46 from the captured content 48. For example, if a photo contains an Arabic representation of the captured time and date, the processor may use OCR to extract the timestamp 46.

The processing system 100 further includes a memory 130. The memory 130, which may be collocated with the storage 110 or processor 120 and may be centralized to a single location or may be spread to disparate points on a network, contains memory to hold the decoded reference time 132 and the extracted timestamp 134. The memory 130 may further contain memory to hold a relative offset or temporal difference 136 between the decoded reference time 132 and the extracted timestamp 134.

The time difference 136 may be used to set an adjusted time associated with a single media content or one or more groupings of media content. For example, one or more parameters configurable by a user and/or a system defined parameter may be used to set an adjusted time to accurately represent the time of collection. A parameter may be used to trigger the setting of an adjusted time for all media content associated with a particular upload event. Furthermore, one or more parameters may be used to trigger the setting of an adjusted time for all media content collected before a particular time, collected after a particular time, collected in a particulate day, week or month, or collected within a particular duration. One or more parameters may be used to trigger the setting of an adjusted time for all media content uploaded before a particular time, uploaded after a particular time, uploaded in a particulate day, week or month, or uploaded within a particular duration.

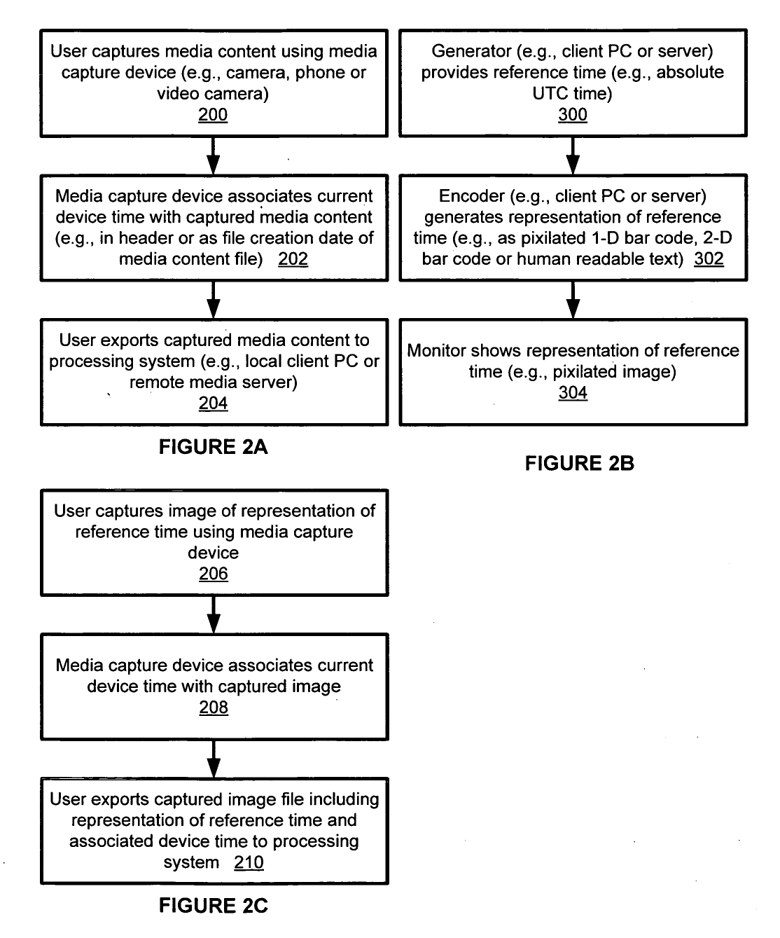

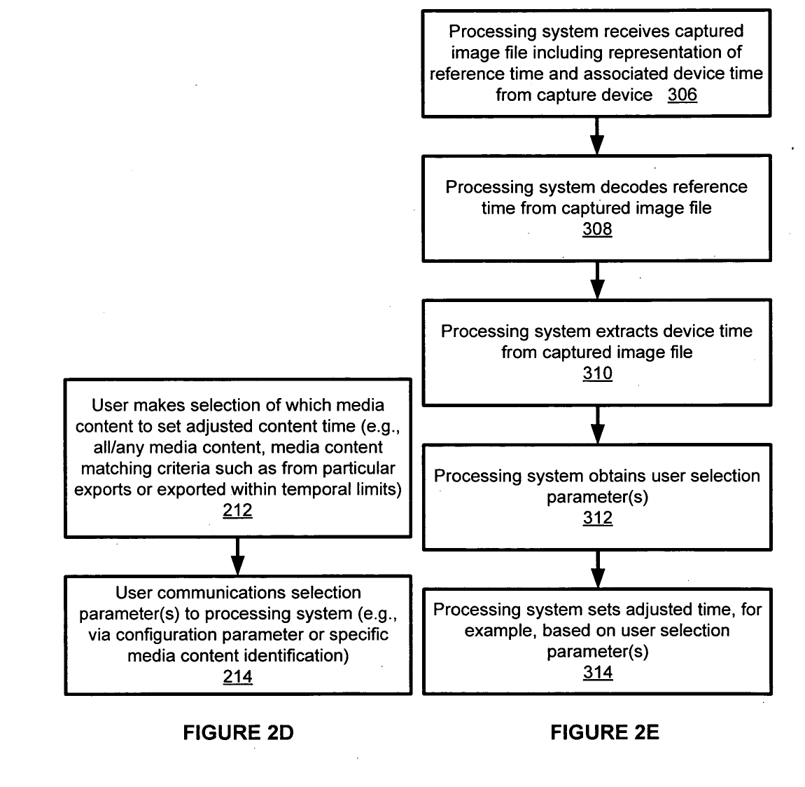

FIGS. 2A through 2E presents user and system process flows, in accordance with some embodiments of the present invention. FIG. 2A shows a process of a user capturing content. At 200, a user captures media content using a media capture device 40, such as a camera, phone or video camera. At 202, the media capture device 40 associates current device time with captured media content. For example, the media capture device 40 places the capture time as a timestamp 46 in a header or as file creation date of media content file. At 204, a user exports captured media content 44 to a processing system 100, such as a local client PC or remote media server.

In FIG. 2B, a system provides a representation 22 of a reference time 15 for a user to capture. At 300, a reference time generator 10, such as a client PC or server, provides a reference time 15. This reference time may be combined date and a universal coordinated time (derived from a source such as UTC time, GMT time, a government maintained standard time, or the like) or may be a local time with or without an indication of a time zone. At 302, a reference time encoder 20, which may be a function performed by a client PC or server, generates a representation 32 of the reference time 15. For example, the representation 32 may be presented as a pixilated 1-D bar code, 2-D bar code or human readable text. At 304, a presentation device such as a monitor 30 provides the representation 32 of reference time 15, for example, as a pixilated image on a web page.

In FIG. 2C, a user captures media content 44A that contains the representations 22 and may later be used for time adjustment operations. At 206, a user captures an image 35 of representation 32 of the reference time using the media capture device 40. At 208, the media capture device 40 associates current device time from the device clock 42 with captured image 48A as a timestamp 46A. At 210, the user exports a captured content 44A including the captured image 48A, such as in a media content file 50 including the representation 32 of the reference time 15 and the associated device timestamp 46A. The user exports the media content file 50 to a processing system 100. Concurrently, previously and/or subsequently, the user may export other media content 44, such as media content 44B, to the processing system 100.

Optionally in FIG. 2D, a user selectively determine which uploaded media content will be time adjusted. At 212, a user makes a selection of which media content to set an adjusted content time. For example, a user may be presented with one or more options to select such as all or any media content, media content matching criteria such as from particular exports or exported within temporal limits. At 214, a user communicates the one or more selection parameters to the processing system 100. For example, a user may have predefined configuration parameters, after-defined configuration parameters, or may identify specific media content. Alternatively, such parameters may be configurable by a system administrator or may me hard coded into executable software.

In FIG. 2E, the processing system 100 manipulates media content. At 306, the processing system 100 receives the captured media content 50, such as an image file, including the content 48A including the representation 32 of the reference time 15 as well as the associated device time, such as timestamp 46A, from capture device 40. At 308, the processing system 100 decodes the reference time 15 as a reconstructed reference time 132 from captured content 50. In some embodiments, the processing system 100 self-determines whether or not captured content 50 contains a representation 32 of the reference time 32. In other embodiments, a user indicates or tags a particular media content 50 as a reference media content for the processing system 100 to decode.

Continuing at 310, the processing system 100 extracts a device time 46A as timestamp 134 from the captured media content 50. Optionally at 312, the processing system 100 obtains user selection parameter(s). The processing system 100 may use the reconstructed reference time 132 and the extracted time stamp 134 to adjust time for this and other associated media content. For example, the processing system 100 may compute an offset or a time difference 136. Optionally at 314, the processing system 100 sets an adjusted time, for example, based on user selection parameters and the time difference 136.

The actions performed as described above are not necessarily performed in the order presented. For example, a user may configure selection parameters before or after uploading content. An offset may be computed as each individual media content is uploaded or may compute offsets after multiple media content is uploaded. Furthermore, the processing system may decode the reference time either before or after it extracts the device timestamp. The order of executing other actions may also be interchanged, delayed and rearranged as those skilled in the art may determine.

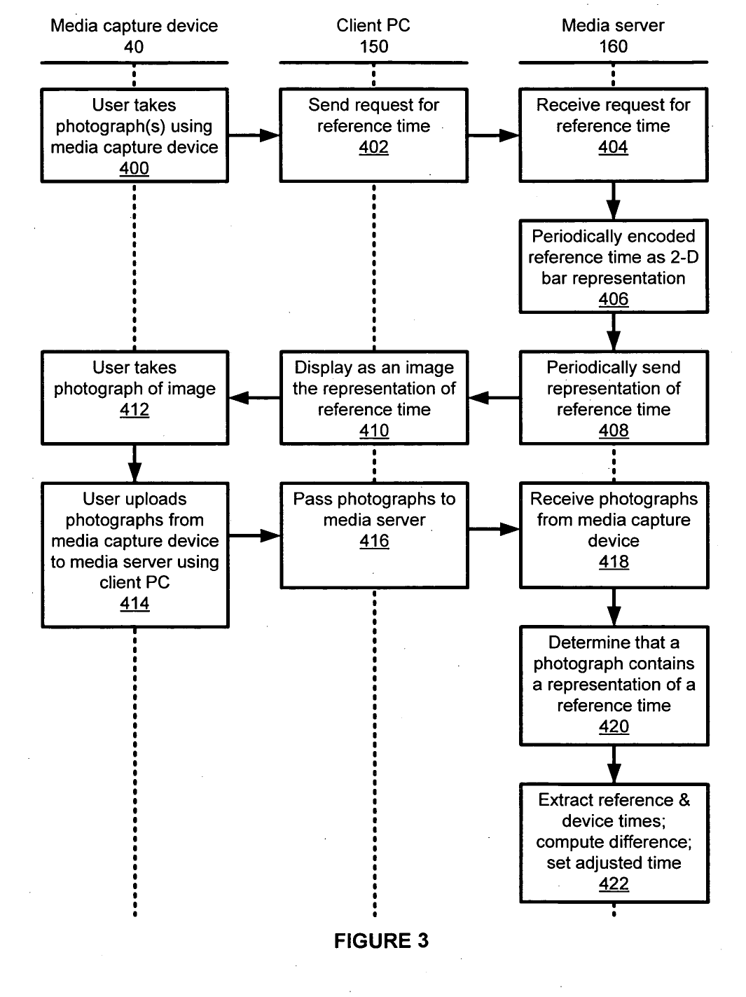

FIG. 3 presents another process flow, in accordance with some embodiments of the present invention. The exemplary system contains a media capture device 40 and a separate processing system 100 that includes a client PC and a media server 160. At 400, a user takes photograph(s) using a media capture device 40, such as a digital camera.

At 402, using the client PC 150, the user send request for display of an encoded reference time. At 404, the media server 160 receives the request for reference time. At 406, the media server 160 may periodically encoded a reference time as 2-D bar representation. At 408, the media server 160 may periodically send an updated representation of reference time to the client PC 150. At 410, the client PC 150 receives and display an image containing the representation of reference time. At 412, the user takes photograph of the displayed image.

At 414 and 416, the user uploads photographs from media capture device 40 to media server 160 using client PC 150. At 418, the media server 160 receives the photographs sent by the media capture device. At 420, the media server 160 determines that a photograph contains a representation of a reference time.

At 422, the media server 160 extracts the reference time and the device timestamp and optionally computes their difference 136. The media server 160 may further set adjusted time for one or more of the uploaded media content base on the difference 136 and optional configuration parameters.

FIG. 4 illustrates an example screenshot showing an encoded 2-dimensional (2-D) barcode representation of a reference time, in accordance with some embodiments of the present invention. The screen shot presented on a display 30 may be a web page. The web page also includes an textual representation of the reference time 15, an encoded 2-dimensional (2-D) barcode representation 32 of a reference time.

FIG. 5 illustrates an example image captured by a media capture device, for example, of the screenshot of FIG. 4, in accordance with some embodiments of the present invention. The captured image 48A is shown to include an integrated device timestamp at 46A. Alternatively, the device timestamp may be stored separately in a header associated with the captured image as described below. The particular example shows a media content device that has a clock that is not calibrate or set properly. The device clock simply shows the duration of time since the device was first powered up. Embodiments of the present invention may accurately determine a time relative to an external clock or reference time as described above.

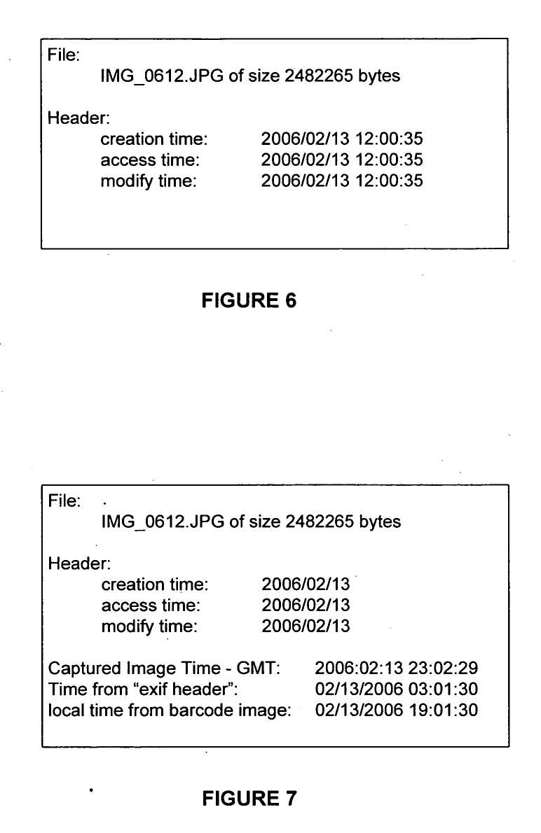

FIG. 6 shows information associated with a captured image, in accordance with some embodiments of the present invention. In the example header, one or more parameters may be included. For example, the header file may include a creation time, a last-access time, and/or a last modified time. The processing system may include rules to select as the extracted time stamp, the creation time if available. If not available, a rule may be to selected a last-access time, and so on.

FIG. 7 shows information associated with a processed image, in accordance with some embodiments of the present invention. The processing system may assemble additional information and associated with header information. For example, the processing system may store in memory the timestamp (shown as a captured image time in GMT format), the reference time (shown as a time from an EXIF header) and a local time (shown as local time from barcode image).

Furthermore, the representation of the reference time may be encoded with additional information. For example, a 2-D bar code may contain a user identifier, a serial number, user preferences, access levels, location identifiers and/or the like. A processing system may further determine a time zone of the user by one of multiple means. For example, the processing system may determine the time zone from a camera property, from a user defined parameter that the user configures into the system, from information in the media content such as longitude/latitude GPS location information stored by the media capture device in the file header, from information extracted from the user's client computer, from the client's PC's Internet IP address, from the user's past actions and/or the like.

While the invention has been described in terms of particular embodiments and illustrative figures, those of ordinary skill in the art will recognize that the invention is not limited to the embodiments or figures described. For example, many of the embodiments described above provide for presentation or collection of a reference time as a still image. In other embodiments, a audio or moving video presentation of a reference time may be provided.

The figures provided are merely representational and may not be drawn to scale. Certain proportions thereof may be exaggerated, while others may be minimized. The figures are intended to illustrate various implementations of the invention that can be understood and appropriately carried out by those of ordinary skill in the art. Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method of associating a device clock from a media content device and a reference time external to the media content device, the method comprising:
receiving media content containing a representation of the reference time;
determining a timestamp derived from the device clock, wherein the timestamp is associated with the received media content; and
reconstructing the reference time from the media content.

2. The method of claim 1, further comprising correlating the timestamp and the reconstructed reference time.

3. The method of claim 2, wherein correlating the timestamp and the reconstructed reference time comprises computing a difference between the timestamp and the reconstructed reference time.

4. The method of claim 1, wherein the media content comprises a video.

5. The method of claim 1, wherein the media content comprises a photographic image.

6. The method of claim 1, wherein determining the timestamp comprises extracting one or more time parameters from a header associated with the media content.

7. The method of claim 1, wherein reconstructing the reference time comprises decoding a bar code.

8. The method of claim 1, wherein reconstructing the reference time comprises performing optical character recognition (OCR) on at least a portion of the media content.

9. The method of claim 1, further comprising setting an adjusted time associated with the media content based on the computed difference.

10. The method of claim 3, further comprising setting an adjusted time associated with the media content based on the timestamp and the reconstructed reference time.

11. The method of claim 1, further comprising detecting whether a portion of the received media content contains a representation of a reference time.

12. The method of claim 1, further comprising receiving additional media content void of the representation of the reference time.

13. The method of claim 12, further comprising detecting that the additional media content is void of the representation of the reference time.

14. The method of claim 12, further comprising setting an adjusted time associated with the additional media content based on the timestamp and the reconstructed reference time.

15. The method of claim 1, further comprising generating the representation of the reference time.

16. The method of claim 1, further comprising providing the representation of the reference time to a web page.

17. A processing system for associating a device clock from a media content device and a reference time external to the media content device, the processing system comprising:
storage;
memory; and
one or more processors coupled to the storage and to the memory, wherein the one or more processors are operable to:
receive media content containing a representation of the reference time;
determine a timestamp derived from the device clock, wherein the timestamp is associated with the received media content; and
reconstruct the reference time from the media content.

18. The processing system of claim 17, further comprising a reference time encoder.

19. The processing system of claim 18, wherein the one or more processors are further operable to correlate the timestamp and the reconstructed reference time.

20. A media content device for associating a device clock from the media content device and a reference time external to the media content device, the media content device comprising:
storage;
memory; and
one or more processors coupled to the storage and to the memory, wherein the one or more processors are operable to:
receive media content containing a representation of the reference time;
determine a timestamp derived from the device clock, wherein the timestamp is associated with the received media content; and
reconstruct the reference time from the media content.

21. The media content device of claim 20, further comprising a barcode encoder operable to encode the reference time.

22. The media content device of claim 20, wherein the one or more processors are further operable to correlate the timestamp and the reconstructed reference time.
